(19) United States
(12) Patent Application Publication
(10) Pub. No.: US 2014/0153505 A1
(43) Pub. Date: Jun. 5, 2014

(54) Methods and Apparatus for Generating a Control Message Frame

(71) Applicant: RENESAS MOBILE CORPORATION, Tokyo (JP)

(72) Inventors: Anna PANTELIDOU, Oulu (FI); Timo Kafevi Koskela, Oulu (FI); Juho Mikko Osakari Pirskanen, Kangasala (FI)

(73) Assignee: RENESAS MOBILE CORPORATION, Tokyo (JP)

(21) Appl. No.: 14/060,178

(22) Filed: Oct. 22, 2013

(30) Foreign Application Priority Data
Oct. 23, 2012 (GB) 1219044.3

(51) Int. Cl. H04W 74/04; H04W 28/06

(52) U.S. Cl. CPC H04W 74/04; H04W 28/065
USPC 370/329

(57) ABSTRACT

A wireless network communication device comprises a host processor, a network interface coupled to the host processor and comprising a transceiver operable to generate and transmit a control message frame. The control message frame includes: a short training field, a long training field, and a signal field including modulation and coding scheme subfield to hold message type information, transmitter address information, receiver address information, and frame check sequence information.

### CROSS REFERENCE TO RELATED APPLICATION

This application claims the benefit under 35 U.S.C. § 119 and 37 CFR § 1.55 to UK patent application no. 1219044.3, filed on Oct. 23, 2012, the entire content of which is incorporated herein by reference.

### TECHNICAL FIELD

The present disclosure relates generally to the field of wireless communications, and particular embodiments relate to short control frame structures for data communication.

### BACKGROUND

The following abbreviations which may be found in the specification and/or the drawing figures are defined as follows:
AP Access Points
BSS Basic Service Set
BSSID Basic Service Set Identifier
CFP Contention-Free Period
CRC Cyclic Redundancy Check
DS Distribution System
EDCA Enhanced Distributed Channel Access
FCS Frame Check Sequence
HCCA Hybrid Coordination Function
LTF Long Training Field
MAC Medium Access Control
MCS Modulation and Coding Scheme
PCF Point Coordination Function
PC Point Coordinator
RA Receiver Address
RAW Restricted Access Window
RSSI Received Signal Strength Indicator
STA Station
STF Short Training Field
S1G Sub-1 GHz
TA Transmitter Address
TXOP Transmission Opportunity
WLAN Wireless Local Area Network

As shown in FIG. 1, when operating in an infrastructure mode, wireless local area networks (WLANs) 10 typically include one or more wireless access points (AP) 12 and one or more client stations (STA) 14. The access point provides the client stations connectivity to the wired networks or distribution system (DS). A basic service set or BSS is a wireless network that includes a single wireless access point supporting one or more wireless stations.

Over the past decade, the Institute for Electrical and Electronics Engineers (IEEE) has developed 802.11a, 802.11b, 802.11g, and 802.11n Standards to achieve improved single-user peak data throughput. For example, the IEEE 802.11b Standard specifies a single-user peak throughput of 11 megabits per second (Mbps), the IEEE 802.11a and 802.11g Standards specify a single-user peak throughput of 54 Mbps, the IEEE 802.11n Standard specifies a single-user peak throughput of 600 Mbps, and the IEEE 802.11ac Standard specifies a single-user peak throughput in the gigabits per second (Gbps) range.

Work is currently underway on a number of new wireless standards, one of which is the IEEE 802.11ah Standard that will specify wireless network operation in sub-1 GHz (S1G) frequencies. Lower frequency communication channels are generally characterised by better propagation qualities and extended propagation ranges. There are a few frequency bands in the sub 1-GHz range that remain unlicensed, with different specific unlicensed frequencies in different geographical regions. The IEEE 802.11ah Standard will specify wireless operation in available unlicensed sub-1 GHz frequency bands.

### SUMMARY

In a first exemplary embodiment of the invention, there is provided a method comprising generating a control message frame comprising a signal field (SIG) to instruct the end a contention-free period, and wirelessly transmitting the control message frame.

In a second exemplary embodiment of the invention, there is provided a wireless network communication device comprising a host processor, a network interface coupled to the host processor and comprising a transceiver operable to generate and transmit a control message frame to instruct the end a contention-free period including: a short training field, a long training field, and a signal field including modulation and coding scheme subfield to hold message type information, transmitter address information, receiver address information, and frame check sequence information.

In a third exemplary embodiment of the invention, there is provided a method of restricted access window operation in a wireless network, the method comprising initiating a restricted access window channel access operation, and generating and transmitting a CF-End message frame at an access point to one or more client stations in response to an instruction to end restricted access window channel access operation.

In a fourth exemplary embodiment of the invention, there is provided a method of restricted access window operation in a wireless network, the method comprising initiating a restricted access window channel access operation, and generating and transmitting a CF-End+CF-Ack message frame at an access point to one or more client stations in response to an instruction to acknowledge a prior message and end restricted access window channel access operation.

In a fifth exemplary embodiment of the invention, there is provided a method of restricted access window operation in a wireless network, the method comprising initiating a restricted access window channel access operation, and generating and transmitting a CF-End message frame at a client station in response to no more data to send and to trigger downstream transmission from an access point.

In a sixth exemplary embodiment of the invention, there is provided a method of restricted access window operation in a wireless network, the method comprising initiating a restricted access window channel access operation, and generating and transmitting a CF-End+CF-Ack message frame at a client station in response to acknowledging a prior message and no more data to send, and to further trigger downstream transmission from an access point.

There may be provided a computer program comprising instructions such that when the computer program is executed by a processing system of a wireless device, the wireless device is arranged to carry out any of the methods as described above.

There may be provided a non-transitory computer-readable storage medium comprising a set of computer-readable instructions stored thereon, which, when executed by a processing system, cause the processing system to carry out any of the methods as described above.

The processing systems described above may comprise at least one processor and at least one memory including computer program instructions, the at least one memory and the computer program instructions being configured to, with the at least one processor, cause the apparatus at least to perform as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a simplified block diagram of an exemplary wireless network;

FIG. 2 shows a more detailed block diagram of an exemplary wireless network;

FIG. 3 shows a diagram illustrating schematically an existing CF-End message format;

FIG. 4 shows a diagram illustrating schematically an existing CF-End+CF-Ack message format; and

FIG. 5 shows a diagram illustrating schematically a shortened message frame format for CF-End message and CF-End+CF-Ack message according to the teachings of the present disclosure.

### DETAILED DESCRIPTION

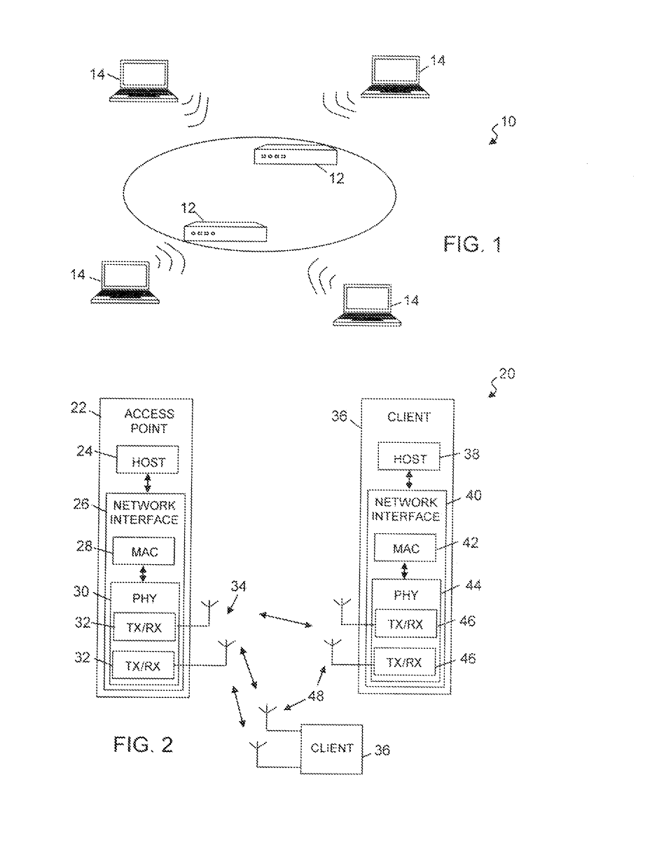

FIG. 2 is a more detailed block diagram of an exemplary wireless network or wireless local area network (WLAN) 20. An access point (AP) 22 includes a host processor 24 coupled to a network interface 26. The network interface 26 includes a Medium Access Control (MAC) processing unit 28 and a Physical (PHY) layer processing unit 30, both of which are operable to execute a plurality of computer program instructions according to the communication protocols. The PHY processing unit 30 includes a plurality of transceivers 32, which are coupled to a plurality of antennas 34.

The wireless network 20 further includes a plurality of client stations (STA) 36 that communicate with the access point 22. Each client station 36 also includes a host processor 38 coupled to a network interface 40. The network interface 40 includes a Medium Access Control (MAC) processing unit 42 and a Physical (PHY) layer processing unit 44, both of which are operable to execute a plurality of computer program instructions according to the communication protocols. The PHY processing unit 44 includes a plurality of transceivers 46, which are coupled to a plurality of antennas 48.

The wireless network device such as the access point 22 of a wireless local area network 20 transmits data streams to one or more client stations via a wireless medium. The access point and client stations are configured to operate according to communication protocols such as IEEE 802.11 and IEEE 802.11ah, for example. The IEEE 802.11ah communication protocol defines data communication operations in a sub-1 GHz frequency range, and is typically used for applications requiring long range wireless communication with relatively low data rates or applications using battery-powered client devices requiring long operating time without battery replacements or re-charging. In some embodiments, the access point is also configured to operate with client stations according to one or more other communication protocols which define operation in generally higher frequency ranges and are typically used for communication in closer ranges and with generally higher data rates.

Because of the long range capabilities of the access point under IEEE 802.11ah, the access point may serve a large number of stations or clients. When the stations are equipped with power amplifiers, reasonable data rates may be achieved at long ranges. However, as the trend is to further reduce the energy consumption of the client devices, the elimination of the power amplifiers provides a viable and desirable solution. Without the use of power amplifiers, the resultant data rates that can be achieved by the stations are drastically reduced. Given the lower data transmission rates in the long range wireless network that mandate long operating time of battery-powered client devices, greater efficiency in the message formats becomes necessary to maintain data throughput, reduce transmission time of control messages, and improve energy efficiency in communication.

Heretofore, short message formats for a number of messages have been introduced for consideration for inclusion in the IEEE 802.11ah Standard specification. However, current discussions have not considered contention-free period (CFP) control message structures.

Contention-Free Period (CFP) is a time period during the operation of a point coordination function (PCF) when the right to transmit is assigned to client stations by a point coordinator (PC), allowing frame exchanges to occur between members of the basic service set (BSS) without contention for the wireless medium. Point coordination function is primarily a poll and response protocol that is used to eliminate the possibility of contention for the wireless medium. The point coordinator typically resides in an access point and periodically initiates a contention-free period to provide a near-isochronous service to the client stations. Data communication during the contention-free period consists of message frames sent from the point coordinator to one or more stations, followed by acknowledgement (Ack) messages received from those stations. In addition to PCF, the Hybrid Coordination Function (HCF) with contention-based Enhanced Distributed Channel Access (EDCA) and HCF-Controlled Channel Access (HCCA) has been defined. Both EDCA and HCCA utilise Transmission Opportunities (TXOPs) for controlling the channel. Traditionally, the CF-End and CF-End+CF-Ack messages have been used by the Point Coordinator (PC) or the Hybrid Coordinator (HC) to indicate the end of a Contention-Free Period (CFP).

In addition to these schemes, the Restricted Access Window (RAW) was introduced in the 802.11ah technology. RAW defines slots in time when access is allowed for certain STAs or STA groups in the uplink or downlink direction based on existing access methods, such as PCF, EDCA, or HCCA.

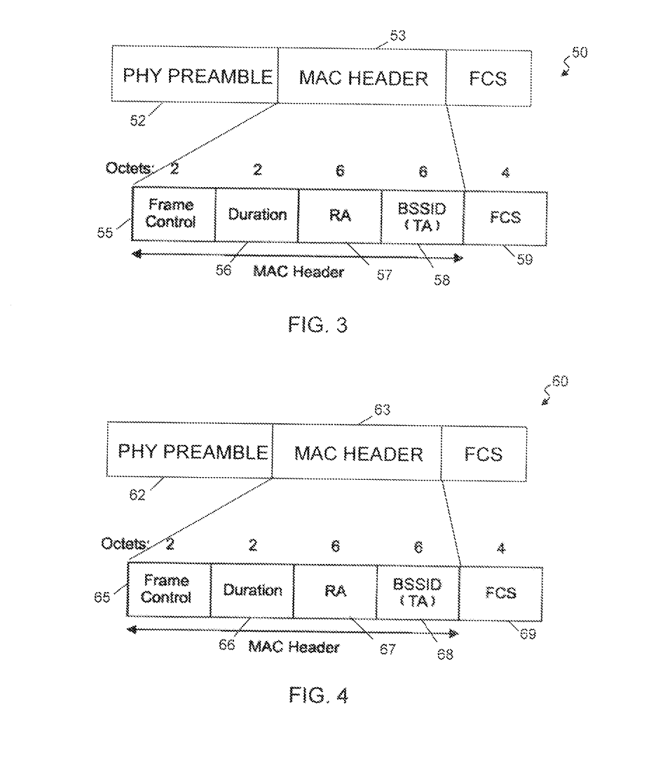

FIG. 3 is a diagram illustrating an existing CF-End message frame format 50. The CF-End message frame format 50 includes a PHY Preamble 52, the details of which are set forth below. Following the PHY Preamble 52 is a Medium Access Control (MAC) Header 53 that includes a number of fields: Frame Control 55, Duration 56, Receiver Address (RA) 57, and Basic Service Set Identifier (BSSID) or Transmitter Address (TA) 58. Pursuant to the IEEE 802.11 Standard, the Frame Control field 55 is a sixteen-bit field that includes a number of subfields (not explicitly shown), including Protocol Version, Message Type, Message Subtype, To DS, From DS, More Fragments, Retry, Power Management, More Data, Protected Frame, and Order. The Message Type and Message Subtype subfields are used to specify the CF-End message. The Duration field 56 is set to zero in the CF-End message frame. The RA field 57 is used to hold the broadcast group address, and the BSSID/TA field 58 is used to hold the address of the station contained in the access point. The CF-End message frame format 50 further includes a Frame Check Sequence (FCS) field 59.

FIG. 4 is a diagram illustrating an existing CF-End+CF-Ack message format structure 60. The CF-End+CF-Ack message is sent to announce the end of the contention-free period and to further acknowledge the receipt of a previous transmission by the point coordinator. The CF-End+CF-Ack message format follows the CF-End message format 50 shown in FIG. 3. As explained above, the Message Type and Message Subtype subfields of the Frame Control field are used to distinguish between the CF-End message and the CF-End+CF-Ack message. The CF-End+CF-Ack message format 60 includes a PHY Preamble 62, the details of which are set forth below. Following the PHY Preamble 62 is a MAC Header 63 that includes a number of fields: Frame Control 65, Duration 66, RA 67, and BSSID or TA 68. The Frame Control field 65 is a sixteen-bit field that includes a number of subfields (not explicitly shown), including Protocol Version, Message Type, Message Subtype, To DS, From DS, More Fragments, Retry, Power Management, More Data, Protected Frame, and Order. The Duration field 66 is set to zero in the CF-End+CF-Ack message frame. Further, the RA field 67 is used to hold the broadcast group address, and the BSSID/TA field 68 is used to hold the address of the station contained in the access point. The CF-End+CF-Ack message frame format 60 further includes an FCS field 69.

In addition to ending the TXOP operation according to EDCA or HCCCA, it may be desirable to end the RAW allocation of one or more slots to/from a STA/group of STAs. RAW CF-End and RAW CF-End+CF-Ack frames are needed for this operation. For simplicity, they are referred to herein as CF-End and CF-End+CF-Ack frames even though it is to be understood that other names can be used for those frames. Under RAW channel access, the AP can send a CF-End frame to an individual STA to stop its slot-based RAW channel access operation, as well as to a specific group of STAs to indicate that their RAW slot period has ended. Additionally, a CF-End message can be used by a STA during a RAW operation if it has no data to send. The STA sending the CF-End message can be the only STA allocated in the particular time slot or a STA that belongs in a group of STAs that can access the channel in the particular time period. Given that a CF-End message, in principle, requires less time to be transmitted than a packet, the remaining slot time can be utilised by the AP, for example to send downlink data to the STA that sent the CF-End message or to another STA or to a group of STAs or to even transmit other frames, e.g. management frames. As another example, the transmission of a CF-End message from an individual STA or from a STA that belongs in a group of STAs indicating the lack of data in the uplink can trigger the downlink transmission during the remaining or part of the remaining of the time slot from the AP to the STA or to the group of STAs. A similar trigger can be initiated when the AP sends a CF-End message indicating the absence of downlink traffic during RAW to its STA or group of STAs, which triggers the STA or group of STAs to start transmitting in the uplink direction during the remaining or part of the remaining of the time slot. If a single STA is triggered then it can transmit having complete channel access during that particular time-slot. If a group of STAs is triggered, those STAs can e.g. compete according to EDCA, to determine which STA or STAs can get the slot. Alternatively, STAs may be assigned different priorities in which case channel access will be given to the STA or STAs with the highest access priority, e.g. those STAs with high requirements for energy efficiency. As another example, during RAW operation a STA or a group of STAs that do not have traffic can send a CF-End in its/their corresponding time slot. This can act as an implicit trigger to the AP that the next instance that this time slot is allocated to the STA or group of STAs, the transmission will occur in the downlink direction. Similarly, transmission of CF-End+CF-Ack from a STA or a group of STAs can signal to the AP that the transmission will occur in the downlink while the STA or group of STAs also acknowledge the reception of a frame from the AP. A similar operation can be expected when the AP sends a CF-End to a STA or to a group of STAs during the time slot that corresponds to them, in which case the next time slot that the STA or group of STAs can access the channel it/they may transmit in the uplink direction. Similarly, a CF-End+CF-Ack sent by an AP indicates that transmission will occur in the uplink direction while at the same time acknowledges reception of a frame from a STA or a group of STAs by the AP. A group is contending in the uplink for instance based on EDCA or some assigned priority. Finally, the AP can broadcast to all the STAs that the RAW operation is terminated with a CF-End message. When CF-End is sent to a group of STAs or to a broadcast address, the individual STAs do not send a CF-Ack message to avoid channel overload. Similarly, the CF-End+CF-Ack can be used to further acknowledge a transmission in addition to ending a RAW channel access.

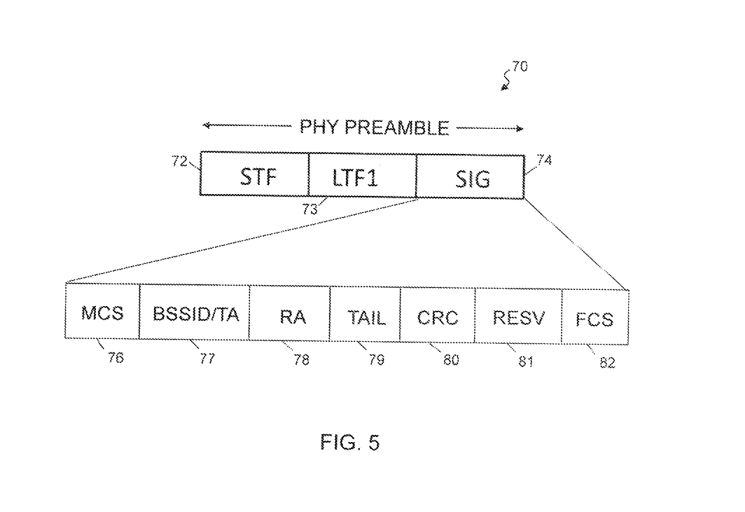

In addition, both the CF-End and CF-End+CF-Ack message formats contain redundant or unnecessary fields that can be eliminated to shorten the messages. FIG. 5 is a diagram illustrating a short message frame format structure 70 for both CF-End message and CF-End+CF-Ack messages according to the teachings of the present disclosure. It should be noted that in the scope of this disclosure, new message types are introduced with short frame structure and by defining a functionality as discussed above or defining functionality that is comparably similar to existing CF-End and CF-End-CF-Ack messages. Therefore introducing a new frame format for existing CF-End and CF-End+CF-Ack is one technical option to introduce reduced frame size for this functionality. The short message structure 70 excludes the MAC Header from the original control message format. Selected information previously contained in the MAC Header is now included in a specially modified SIG field of the PHY Preamble, to be described below.

The CF-End and CF-End+CF-Ack message format 70 includes a PHY Preamble that includes a Short Training Field (STF) 72, a Long Training Field (LTF1) 73, and a modified Signal (SIG) field 74. The STF and LTF1 fields generally remain unchanged from the existing IEEE 802.11 Standard specifications and are not described in more detail for the sake of brevity. However, some of the information previously contained in the MAC header is now included in the modified SIG field 74. The modified SIG field 74 includes a Modulation and Coding Scheme (MCS) subfield 76, a BSSID/TA subfield 77, an RA subfield 78, a Tail subfield 79, a Cyclic Redundancy Check (CRC) subfield 80, a Reserved subfield 81, and an Frame Check Sequence (FCS) subfield 82.

The modified SIG field 84 may include a four-bit MCS subfield 86 that is reserved for specifying the modulation and coding level, as well as additionally specifying the message type and subtype information of the control frame. The BSSID/TA subfield 87 may be full or partial BSSID. The RA subfield 88 may hold an Association Identity (AID) or a Group ID used e.g. for the RAW procedure or another mechanism that groups the STAs or a broadcast group address. Those addresses or Identities can be given in the RA field in either a full or partial format to reduce the number of bits required to specify them. The RA field can have a two-fold meaning, namely it can indicate, for instance, the a) intended receiver address, e.g. a STA or group of STAs that should receive the frame, or b) a broadcast or group address that is allowed to overhear the message. The AID and/or Group ID are the values assigned to the station transmitting the frame by the access point in the association response frame that established that station's current association. If the number of stations exceeds 6,000, for example, then thirteen bits are used for the AID when the full AID is used. The group ID can be a logical group, e.g. by a signalled set of an AID range of addresses, or a physical group that could be created by, for example, using some antenna beam pattern. The number of bits needed to describe the group ID depends on the logical or physical size of the group. In order to indicate the type of RA address, i.e. if it is an AID, a group ID or a broadcast address, the first 2 bits of the RA field can be used to signal this information. Alternatively, a new additional field can be included in the frame of FIG. 5. Further, the BSSID/TA and RA subfields may be optional depending on which network entity is the sending device. If for example a station is the transmitting entity of the control frame in a RAW message exchange where a STA is given a slot to transmit uplink data to the AP, then the RA subfield may be optional and not included in the message. On the other hand, if an access point is the transmitting entity of the control frame in a RAW message exchange, then the BSSID information may be optional and may not be included in the message. Additionally, the CF-End or CF-End+CF-Ack message frame may be piggybacked onto another data frame in the TXOP (Transmission Opportunity) or in the RAW access. These piggybacked-on-data CF-End and CF-End+CF-Ack messages can be indicated in the type-subtype fields of the data frame, by for example using the reserved values. In this case, and when the receiver address has the meaning of the receiving entity (not the meaning of a broadcast overhearing address), the transmitter and receiver addresses have already been specified in that data frame and the BSSID/TA and RA subfields become redundant and do not need to be included again in the CF-End or CF-End+CF-Ack message frame. The short CF-End or CF-End+CF-Ack message frames can be used to stop the channel reservation and release it for other users in case of PCF operation or during a TXOP operating based on EDCA or HCCA. Especially during an HCCA TXOP operation, the HCF can send the short CF-End frame to the STA which is the TXOP holder or alternatively the TXOP holder by itself can send the short CF-End frame to indicate e.g. the lack of additional data and to release the channel. When a short CF-End frame is sent to an individual STA, the receiver responds with a short CF-Ack message. In addition, short CF-End and CF-End+CF-Ack frames can be used for the RAW channel access, similarly to the normal sized CF-End and CF-End+CF-Ack message exchange described above.

The different types of CF-End and CF-End+CF-Ack messages, e.g. if they are long or short versions of those and whether they correspond to RAW or to a normal TXOP (EDCA or HCCA), can be indicated through the type and subtype fields and through, e.g. the reserved MCS bits.

The modified SIG field 74 further includes the Tail subfield 79 which is set to zero as in the current physical layer SIG frame to reset the convolutional coder, CRC subfield 80 which is calculated from MCS 76, BSSID 77, RA 78, and optionally from Tail 79, Reserved subfield 81, as specified in the existing IEEE 802.11 Standard. The FCS subfield from the prior message formats is also brought into the modified SIG field 74.

It may be noted that FIG. 5 illustrates an exemplary order in which the subfields are organised in the SIG field 74 and these subfields need not be configured in this manner. The modified SIG field 74 may further include other additional subfields not described herein.

Configured in this manner, the proposed new short format for the CF-End and CF-End+CF-Ack messages no longer includes the bulky MAC Header, but retains only needed information such as the message type, message subtype, transmitter address, and receiver address. Accordingly, at least four octets have been eliminated from the message format (the Frame Control and Duration fields), with even more reduction from eliminating the BSSID/TA and/or RA subfields as well.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method comprising:
generating a control message frame comprising a signal field (SIG) to instruct the end a contention-free period; and
wirelessly transmitting the control message frame.

2. A method according to claim 1, wherein the said signal field is generated in response to an instruction to acknowledge a prior message and to end a contention-free period.

3. A method according to claim 1, wherein the said signal field is used to instruct the end restricted access window (RAW) period.

4. A method according to claim 1, wherein the said signal field comprises message type, transmitter and receiver address information, and frame check sequence information.

5. A method according to claim 1, wherein generating a control message frame comprises at least one of:
generating a short training field and a long training field;
generating a signal field without the transmitter address information;
generating a signal field without the receiver address information;
generating a signal field that includes a MCS subfield, optional BSSID/TA subfield, optional RA subfield, Tail subfield, CRC subfield, Reserved subfield, and FCS subfield;
generating the control message frame in response to an instruction to end an HCF (hybrid coordination function) controlled channel access period;
generating the control message frame in response to an instruction to end an enhanced distributed channel access period;
generating the control message frame in response to no more data to send at a client station;
generating the contention-free control message frame to include a group receiver address.

6. A method according to claim 1, wherein generating the control message frame comprises generating the control message frame at an access point of a wireless network.

7. A method according to claim 1, wherein generating the control message frame comprises generating the control message frame at a client station in a wireless network.

8. A method according to claim 1, wherein generating and wirelessly transmitting a control message frame comprises generating and transmitting the control message frame to trigger uplink or downlink transmission for one or more client stations in a current restricted access window time slot.

9. A method according to claim 1, wherein generating and wirelessly transmitting a control message frame comprises generating and transmitting the control message frame to trigger an uplink or downlink transmission in a next restricted access window time slot.

10. A wireless network communication device comprising:
a host processor;
a network interface coupled to the host processor and comprising a transceiver operable to generate and transmit a control message frame to end a contention-free period including:
a short training field;
a long training field; and
a signal field including modulation and coding scheme subfield to hold message type information, transmitter address information, receiver address information, and frame check sequence information.

11. A wireless network communication device according to claim 10, wherein the transceiver is operable to at least one of:
generate a signal field that includes a signal field without the transmitter address information;
generate a signal field that includes a signal field without the receiver address information;
generate a signal field that includes a signal field that includes a MCS subfield, optional BSSID/TA subfield, optional RA subfield, Tail subfield, CRC subfield, Reserved subfield, and FCS subfield;
generate the control message frame in response to an instruction to end restricted access window operation;
generate the control message frame in response to an instruction HCF (hybrid coordination function) controlled channel access period;
generate the control message frame in response to an instruction to end an enhanced distributed channel access period; and
generate the control message frame in response to no more data to send at a client station.

12. A wireless network communication device according to claim 10, wherein the transceiver is operable to generate the control message at an access point of a wireless network or at a client station in a wireless network.

13. A wireless network communication device according to claim 10, wherein the transceiver is operable to generate and wirelessly transmit the control message frame to trigger uplink or downlink transmission in a current restricted access window time slot.

14. A wireless network communication device according to claim 10, wherein the transceiver is operable to generate and wirelessly transmit the control message frame to trigger an uplink or downlink transmission in a next restricted access window time slot.

15. A wireless network communication device according to claim 10, wherein the transceiver is operable to generate and wirelessly transmit the control message frame to contain a group receiver address.

16. A wireless network communication device according to claim 10, wherein the transceiver is operable to generate and wirelessly transmit the control message frame to contain a broadcast address.

17. A method of restricted access window operation in a wireless network, the method comprising:
initiating a restricted access window channel access operation; and
generating and transmitting a CF-End message frame at an access point to one or more client stations in response to an instruction to end restricted access window channel access operation.

18. A method of restricted access window operation in a wireless network, the method comprising:
initiating a restricted access window channel access operation; and
generating and transmitting a CF-End+CF-Ack message frame at an access point to one or more client stations in response to an instruction to acknowledge a prior message and end restricted access window channel access operation.

19. A method of restricted access window operation in a wireless network, the method comprising:
initiating a restricted access window channel access operation; and
generating and transmitting a CF-End message frame at a client station in response to no more data to send and to trigger downstream transmission from an access point.

20. A method of restricted access window operation in a wireless network, the method comprising:
initiating a restricted access window channel access operation; and
generating and transmitting a CF-End+CF-Ack message frame at a client station in response to acknowledging a prior message and no more data to send, and to further trigger downstream transmission from an access point.
